(19) United States
(12) Patent Application Publication
(10) Pub. No.: US 2026/0368119 A1
(43) Pub. Date: Nov. 19, 2026

(54) AGGREGATION UNIVERSAL SERIAL BUS DEVICE AND MODE SELECTION METHOD THEREOF

(71) Applicant: Realtek Semiconductor Corporation, Hsinchu (TW)

(72) Inventors: Hung-Chi WEI, Hsinchu (TW); Chia Hua HSU, Hsinchu (TW)

(21) Appl. No.: 19/678,207

(22) Filed: May 15, 2026

(30) Foreign Application Priority Data
May 19, 2025 (TW) 114118734

(51) Int. Cl. G06F 13/40

(52) U.S. Cl. CPC G06F 13/4022; G06F 2213/0042

(57) ABSTRACT

A universal serial bus device includes a detection circuit, a de-multiplexer circuit and a mode selection circuit. The detection circuit is configured to detect a supply voltage supplied by a host side device from a power wire. The de-multiplexer circuit is electrically connected between multiple data wires and multiple physical layers. The mode selection circuit is electrically connected to the detection circuit and the de-multiplexer circuit, and the mode selection circuit is configured to perform the following steps. Select one of multiple operation modes as a selected mode according to the supply voltage. Control the de-multiplexer circuit to connect the data wires to one of the physical layers according to the selected mode, such that the universal serial bus device operates in the selected mode.

### CROSS-REFERENCE TO RELATED APPLICATION

This application claims priority to Taiwan Application Serial Number 114118734, filed May 19, 2025, which is herein incorporated by reference in its entirety.

### BACKGROUND

### Technical Field

The present invention relates to a universal serial bus device and a mode selection method thereof, and in particular, to a universal serial bus device capable of automatically selecting operation modes and a mode selection method thereof.

### Description of Related Art

In the Universal Serial Bus (USB) technology, USB2 is gradually moving towards low-voltage embedded USB2 applications. In signal transmission, the current specification requires that the voltages are completely matched in order to operate normally. The USB Developer Forum proposes a repeater mode in which a host side device is connected to different equipment side devices through a repeater chip to achieve signal voltage matching. However, this requires additional circuits and increases costs. Therefore, how to solve the above problems is an important issue in this field.

### SUMMARY

An aspect of the present disclosure provides a Universal Serial Bus (USB) device, comprising a detection circuit, a de-multiplexer circuit and a mode selection circuit. The detection circuit is configured to detect a supply voltage supplied by a host side device from a power wire. The de-multiplexer circuit is electrically connected between multiple data wires and multiple physical layers. The mode selection circuit is electrically connected to the detection circuit and the de-multiplexer circuit, and the mode selection circuit is configured to perform the following steps. Select one of multiple operation modes as a selected mode according to the supply voltage. Control the de-multiplexer circuit to connect the data wires to one of the physical layers according to the selected mode, such that the USB device operates in the selected mode.

Another aspect of the present disclosure provides a mode selection method for a USB device. The USB device comprises a detection circuit, a de-multiplexer circuit, and a mode selection circuit. The de-multiplexer circuit is electrically connected between multiple data wires and multiple physical layers. The mode selection circuit is electrically connected to the detection circuit and the de-multiplexer circuit, and the mode selection method comprises the following steps. Detect, by the detection circuit, a supply voltage supplied by a host side device from a power wire. Select, by the mode selection circuit, one of multiple operation modes as a selected mode according to the supply voltage. Control, by the mode selection circuit, the de-multiplexer circuit to connect the data wires to one of the physical layers according to the selected mode, such that the USB device operates in the selected mode.

Another aspect of the present disclosure provides a USB device, comprising a detection circuit, a de-multiplexer circuit and a mode selection circuit. The detection circuit is configured to detect multiple signal voltages supplied by a host side device from multiple data wires. The de-multiplexer circuit is electrically connected between the data wires and multiple physical layers. The mode selection circuit is electrically connected to the detection circuit and the de-multiplexer circuit, and the mode selection circuit is configured to perform the following steps. Select one of multiple operation modes as a selected mode according to the signal voltages. Control the de-multiplexer circuit to connect the data wires to one of the physical layers according to the selected mode, such that the USB device operates in the selected mode.

In summary, the USB device and the mode selection method in the present disclosure can automatically select the operation mode of the USB device, thereby communicating with the host side device and transmitting data.

### BRIEF DESCRIPTION OF THE DRAWINGS

To make the above and other purposes, features, advantages and embodiments of the present disclosure more clearly understandable, the attached drawings are described as follows:

FIG. 1A is a schematic diagram of a communication architecture of a universal serial bus device according to an embodiment of the present disclosure.

FIG. 1B is a schematic diagram of the universal serial bus device according to an embodiment of the present disclosure.

FIG. 1C is a schematic diagram of the universal serial bus device according to an embodiment of the present disclosure.

FIG. 2A is a schematic diagram of a mode selection method according to an embodiment of the present disclosure.

FIG. 2B is a schematic diagram of step 230 of the mode selection method of FIG. 2A according to an embodiment of the present disclosure.

FIG. 3 is a schematic diagram of a communication architecture of a universal serial bus device according to an embodiment of the present disclosure.

FIG. 4 is a schematic diagram of a communication architecture of the universal serial bus device according to an embodiment of the present disclosure.

FIG. 5A is a schematic diagram of a mode selection method according to an embodiment of the present disclosure.

FIG. 5B is a schematic diagram of step 530 of the mode selection method of FIG. 5A according to an embodiment of the present disclosure.

FIG. 6 is a schematic diagram of a communication architecture of a universal serial bus device according to an embodiment of the present disclosure.

### DETAILED DESCRIPTION

The following is a detailed description of embodiments with the accompanying drawings, but the embodiments provided are not intended to limit the scope of the present disclosure, and the description of structural operation is not intended to limit its execution order. Any device with equal functions generated by re-combination of elements is within the scope of the present disclosure. In addition, the drawings are for illustration purposes only and are not drawn according to the original size. For ease of understanding, the same or similar elements in the following description will be described with the same symbols.

The terms used throughout the specification and the claims, and generally have the ordinary meaning of each term used in this field, in the content of this disclosure and in the special content, unless otherwise specified. In addition, the terms “comprise”, “include”, “have”, “contain”, etc. used herein are all open terms, meaning “including but not limited to”. In addition, “and/or” used herein includes any one or more of the relevant listed items and all combinations thereof.

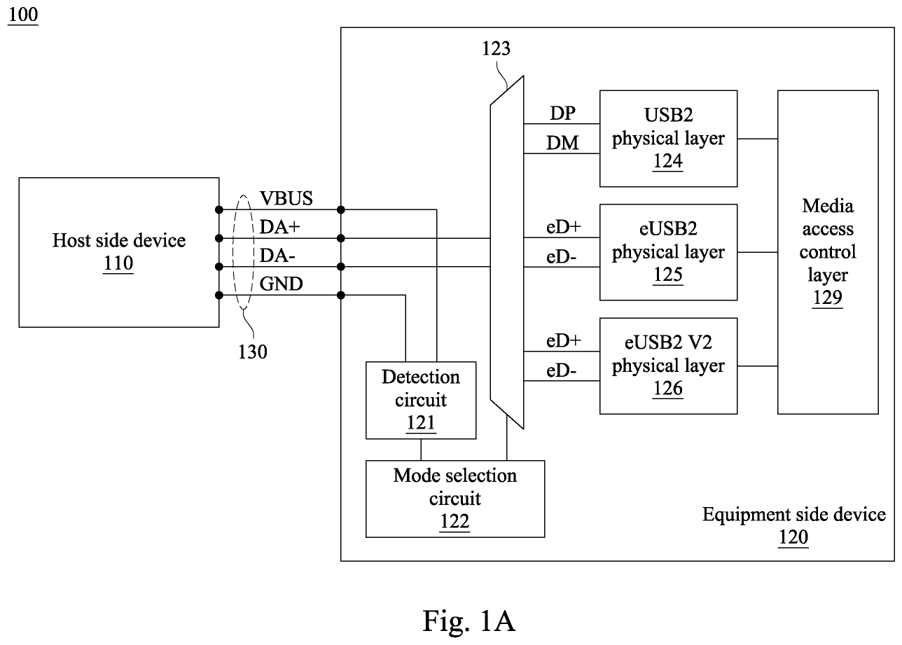

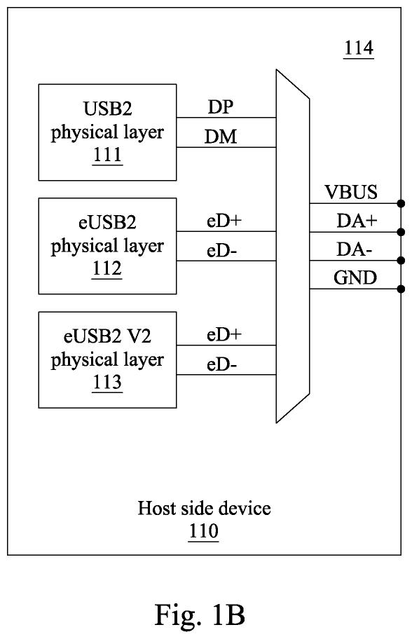

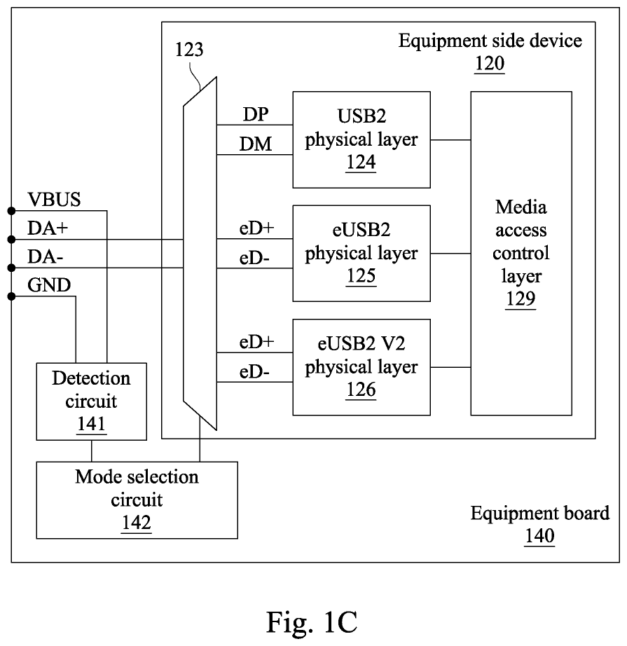

Reference is made FIG. 1A. FIG. 1A is a schematic diagram of a communication architecture 100 of a Universal Serial Bus (USB) device according to an embodiment of the present disclosure. In an embodiment of FIG. 1A, the USB device on a host side is a host side device 110 as an example, and the USB device on an equipment side is an equipment side device 120 as an example. In some embodiments, the USB device on the equipment side can also be a repeater or a USB hub. Therefore, the present disclosure is not limited thereto. In some embodiments, the USB device can be an On-The-Go device with dual-role function. In some embodiments, the USB device is an aggregation USB device.

In some embodiments, signals that can be output by the host side device 110 conform to the specifications of at least one of USB2, embedded USB 2 (eUSB2), and embedded USB 2 version 2 (eUSB2 V2). In some embodiments, the host side device 110 is connected to the equipment side device 120 via a signal wire 130. In some embodiments, the signal wire 130 includes power wires (e.g., a VBUS wire and a GND wire) and data wires (e.g., a DA+ wire and a DA− wire). In some embodiments, signals transmitted by the signal wire 130 conform to the specifications of at least one of USB2, eUSB2, and eUSB2 version 2.

In some embodiments, the equipment side device 120 can be a chip. In some embodiments, the equipment side device 120 can be a single chip. In some embodiments, the equipment side device 120 is a network control interface or other controller, but the present disclosure is not limited thereto. In some embodiments, the equipment side device 120 includes a detection circuit 121, a mode selection circuit 122, a de-multiplexer circuit 123, at least two of multiple physical layers (e.g., a USB2 physical layer 124, an eUSB2 physical layer 125, and an eUSB2 V2 physical layer 126), and a media access control layer 129.

In some embodiments, the detection circuit 121 can be a voltage detection circuit configured to detect a supply voltage supplied by the host side device 110 from a power wire (e.g., the VBUS wire) to generate an output.

In some embodiments, the mode selection circuit 122 can be a logic circuit (e.g., a combination of comparators) configured to: select one of multiple preset modes according to the output of the detection circuit 121, and control the de-multiplexer circuit 123 to connect the data wires (e.g., DA+ and DA−) to one of multiple physical layers (e.g., the USB2 physical layer 124, the eUSB2 physical layer 125, and the eUSB2 V2 physical layer 126) according to the selected mode, such that the equipment side device 120 operates in the selected mode. The plurality of preset modes include at least two of the USB2 mode, the eUSB2 mode, and the eUSB2 V2 mode. In some embodiments, multiple preset voltages are different from each other, and the preset voltages are used for setting the mode of the equipment side device 120 to multiple operation modes respectively. In some embodiments, the mode selection circuit 122 is further configured to: determine that one of multiple preset voltages corresponds to the supply voltage supplied by the host side device 110, and select the corresponding operation mode as the selected mode according to the corresponding one of multiple preset voltages.

In the USB2 mode, the de-multiplexer circuit 123 connects the data wires (e.g., the DA+ wire and the DA− wire) to DP and DM wires of the USB2 physical layer 124, respectively.

In the eUSB2 mode, the de-multiplexer circuit 123 connects the data wires (e.g., the DA+ wire and the DA− wire) to eDP and eD-wires of the eUSB2 physical layer 125, respectively.

In the eUSB2 V2 mode, the de-multiplexer circuit 123 connects the data wires (e.g., the DA+ wire and the DA− wire) to eDP and eD-wires of the eUSB2 V2 physical layer 126, respectively.

In some embodiments, in the above modes, the relationship between the preset voltage and the mode can be represented in the following Table 1.

TABLE 1

| | USB2 mode | eUSB2 mode | eUSB2 V2 mode |
|---|---|---|---|
| VBUS | First preset | Second preset | Third preset |
| | voltage (e.g., 5 V) | voltage (e.g., 4 V) | voltage (e.g., 3 V) |

In some embodiments, the first preset voltage is greater than the second preset voltage, and the second preset voltage is greater than the third preset voltage. In some embodiments, if the supply voltage is the first preset voltage, it is sufficient for the equipment side device 120 to operate in the USB2 mode. In some embodiments, if the supply voltage is the second preset voltage, it is sufficient for the equipment side device 120 to operate in the eUSB2 mode. In some embodiments, if the supply voltage is the third preset voltage, it is sufficient for the equipment side device 120 to operate in the eUSB2 V2 mode.

In some embodiments, the media access control layer 129 is a USB2 media access control layer. In some embodiments, hardware of the media access control layer 129 can be implemented by a processor, a microcontroller, or a microprocessor. In some embodiments, the media access control layer 129 is connected to the USB2 physical layer 124, the eUSB2 physical layer 125, and the eUSB2 V2 physical layer 126.

Reference is made FIG. 1B. FIG. 1B is a schematic diagram of the universal serial bus device according to an embodiment of the present disclosure. In some embodiments, the USB device on the host side is a host side device 110 as an example. In some embodiments, the host side device 110 can be a chip. In some embodiments, the host side device 110 can be a single chip. As shown in FIG. 1B, the host side device 110 includes one or more physical layers (for example, at least one of the USB2 physical layer 111, the eUSB2 physical layer 112, and the eUSB2 V2 physical layer 113) to output a signal that conforms to the specifications. In some embodiments, if the host side device 110 includes multiple physical layers, a desired path can be selected through a multiplexer to switch the output signal.

Reference is made to FIG. 1C. FIG. 1C is a schematic diagram of the universal serial bus device according to an embodiment of the present disclosure. In some embodiments, the USB device on the equipment side is an equipment board 140 as an example. In some embodiments, the equipment board 140 can be a printed circuit board assembly. In some embodiments, the equipment board 140 includes a detection circuit 141 and a mode selection circuit 142. In some examples, the operations and functions of the detection circuit 141 and the mode selection circuit 142 are similar to those of the detection circuit 121 and the mode selection circuit 122 of FIG. 1A, and are not described in detail here.

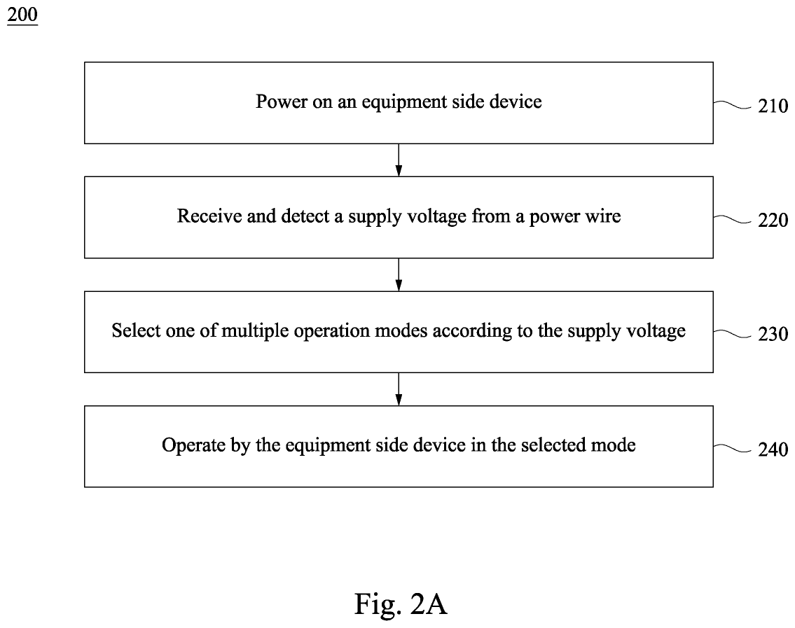

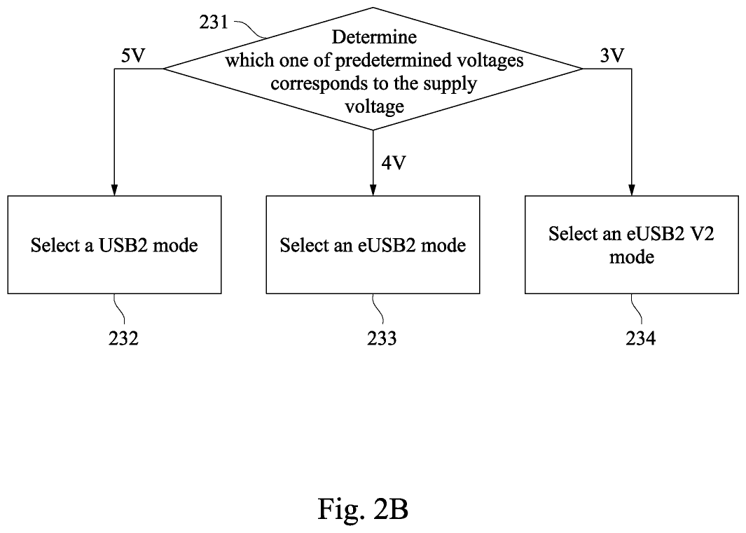

Reference is made to FIG. 2A. FIG. 2A is a schematic diagram of a mode selection method 200 according to an embodiment of the present disclosure. As shown in FIG. 2A, the mode selection method 200 includes steps 210-240. In step 210, the equipment side device is powered on. In step 220, the supply voltage is received and detected from the power wire. In step 230, one of multiple operation modes is selected according to the supply voltage. In step 240, the equipment side device operates in the selected mode.

Reference is made to FIG. 2B. FIG. 2B is a schematic diagram of step 230 of a mode selection method 200 of FIG. 2A according to an embodiment of the present disclosure. As shown in FIG. 2B, step 230 includes steps 231-234. In step 231, it is determined which one of the preset voltages corresponds to the supply voltage. In step 232, the USB2 mode is selected. In step 232, the eUSB2 mode is selected. In step 232, the eUSB2 V2 mode is selected.

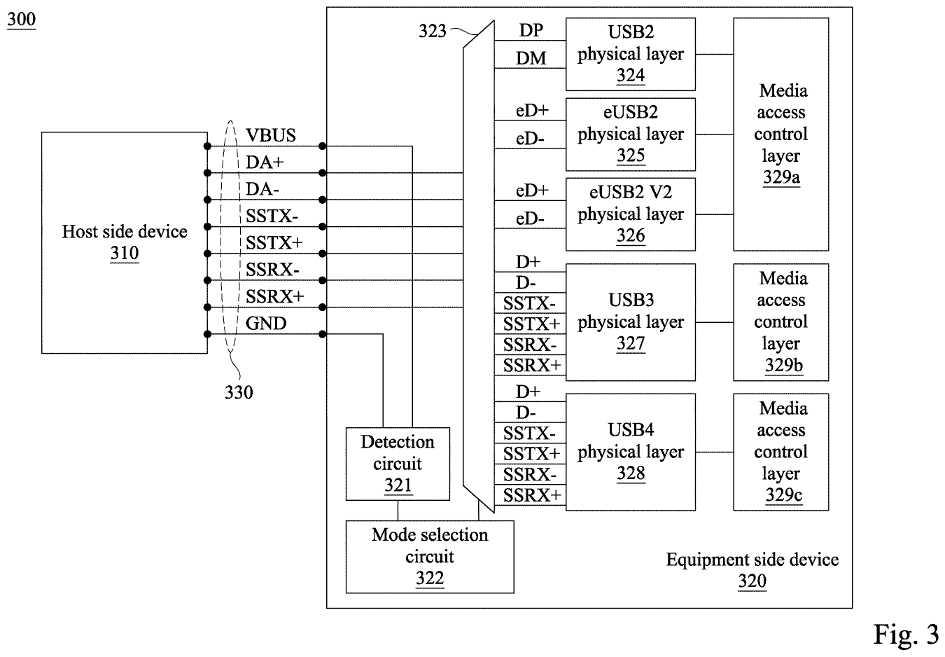

Reference is made to FIG. 3. FIG. 3 is a schematic diagram of a communication architecture 300 of a universal serial bus device according to an embodiment of the present disclosure. In some embodiments, signals output by the host side device 310 conform to the specifications of at least one of USB2, eUSB2, eUSB2 V2, USB3 and USB4. In some embodiments, the host side device 310 is connected to the equipment side device 320 via a signal wire 330. In some embodiments, the signal wire 330 includes power wires (e.g., VBUS wire and GND wire) and data wires (e.g., DA+ wire, DA− wire, SSTX− wire, SSTX+ wire, SSRX− wire, and SSRX+ wire). In some embodiments, signals transmitted by the signal wire 330 conform to the specifications of at least one of USB2, eUSB2, eUSB2 V2, USB3, and USB4.

In FIG. 3, the USB device on the device side is an equipment side device 320 as an example. In some embodiments, the equipment side device 320 includes a detection circuit 321, a mode selection circuit 322, a de-multiplexer circuit 323, at least two of multiple physical layers (e.g., a USB2 physical layer 324, an eUSB2 physical layer 325, an eUSB2 V2 physical layer 326, a USB3 physical layer 327, and a USB4 physical layer 328), and at least one of media access control layers (e.g., media access control layers 329a-329c). In some embodiments, the functions and operations of the detection circuit 321, the mode selection circuit 322, the de-multiplexer circuit 323, the USB2 physical layer 324, the eUSB2 physical layer 325, the eUSB2 V2 physical layer 326, and the media access control layer 329a correspond to the detection circuit 121, the mode selection circuit 122, the de-multiplexer circuit 123, the USB2 physical layer 124, the eUSB2 physical layer 125, the eUSB2 V2 physical layer 126, and the media access control layer 129 in FIG. 1A, and are not described in detail here.

In the USB3 mode, the de-multiplexer circuit 323 connects data wires included in the signal wire 330 to the USB3 physical layer 327.

In the USB4 mode, the de-multiplexer circuit 323 connects data wires included in the signal wire 330 to the USB4 physical layer 328.

In some embodiments, hardware of the media access control layer 329b and 329c can be implemented by a processor, a microcontroller or a microprocessor. In some embodiments, the media access control layers 329b and 329c can be a USB3 media access control layer and a USB4 media access control layer, respectively.

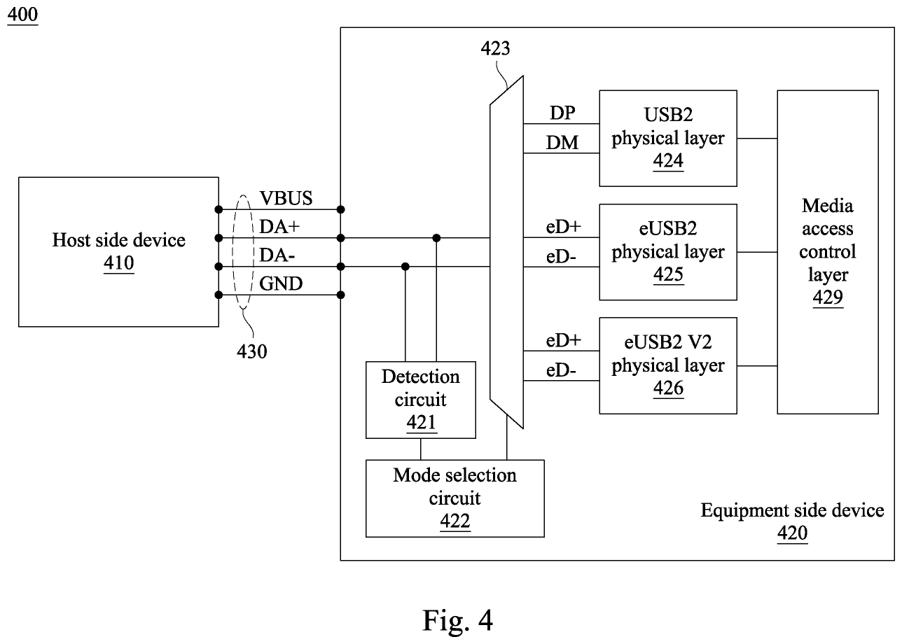

Reference is made to FIG. 4. FIG. 4 is a schematic diagram of a communication architecture 400 of a universal serial bus device according to an embodiment of the present disclosure. In the embodiment of FIG. 4, the USB device on the host side is a host side device 410 as an example, and the USB device on the equipment side is an equipment side device 420 as an example. In some embodiments, the USB device on the device side can also be a repeater or a USB hub. Therefore, the present disclosure is not limited thereto. In some embodiments, the USB device can be an On-The-Go device with dual-role function.

In some embodiments, signals that can be output by the host side device 410 conform to the specifications of at least one of USB2, embedded USB 2 (eUSB2), and embedded USB 2 version 2 (eUSB2 V2). In some embodiments, the host side device 410 is connected to the equipment side device 420 via a signal wire 430. In some embodiments, the signal wire 430 includes power wires (e.g., a VBUS wire and a GND wire) and data wires (e.g., a DA+ wire and a DA− wire). In some embodiments, signals transmitted by the signal wire 430 conform to the specifications of at least one of USB2, eUSB2, and eUSB2 version 2.

In some embodiments, the equipment side device 420 can be a chip. In some embodiments, the equipment side device 420 can be a single chip. In some embodiments, the equipment side device 420 is a network control interface or other controller, but the present disclosure is not limited thereto. In some embodiments, the equipment side device 420 includes a detection circuit 421, a mode selection circuit 422, a de-multiplexer circuit 423, at least two of multiple physical layers (e.g., a USB2 physical layer 424, an eUSB2 physical layer 425, and an eUSB2 V2 physical layer 426), and a media access control layer 429.

In some embodiments, the detection circuit 421 can be a voltage detection circuit configured to detect signal voltages supplied by the host side device 110 from data wires (e.g., a DA+ wire and a DA−) to generate an output.

In some embodiments, the mode selection circuit 422 can be a logic circuit (e.g., a combination of comparators) configured to: select one of multiple preset modes according to the output of the detection circuit 421, and control the de-multiplexer circuit 423 to connect the data wires (e.g., DA+ and DA−) to one of multiple physical layers (e.g., the USB2 physical layer 424, the eUSB2 physical layer 425, and the eUSB2 V2 physical layer 426) according to the selected mode, such that the equipment side device 420 operates in the selected mode. The plurality of preset modes include at least two of the USB2 mode, the eUSB2 mode, and the eUSB2 V2 mode. In some embodiments, multiple preset voltage groups are different from each other, and the preset voltage groups are used for setting the mode of the equipment side device 420 to multiple operation modes, respectively. In some embodiments, the preset voltage group in each operation mode refers to a set of signal voltages transmitted on the data wires. In some embodiments, the selection of the preset voltage groups may depend on a predetermined value (the predetermined value is 1.2 V as an example in the subsequent embodiments). In other embodiments, the selection of the preset voltage groups may depend on more predetermined values, thereby providing more operation mode switching, and the present disclosure is not limited thereto. In some embodiments, the mode selection circuit 422 is further configured to: determine that one of multiple preset voltage groups corresponds to the signal voltages supplied by the host side device 410, and select a corresponding operation mode as the selected mode according to the corresponding one of multiple preset voltage groups.

In some embodiments, in the multiple preset modes above, the relationship between the preset voltage group and the mode can be represented in the following Table 2.

TABLE 2

| | USB2 mode | eUSB2 mode | eUSB2V2 mode |
|---|---|---|---|
| DA+ | <1.2 V | Only one of the signal | =1.2 V |
| DA− | <1.2 V | voltages on the DA+ | =1.2 V |
| | | and DA− wires is 1.2 V | |

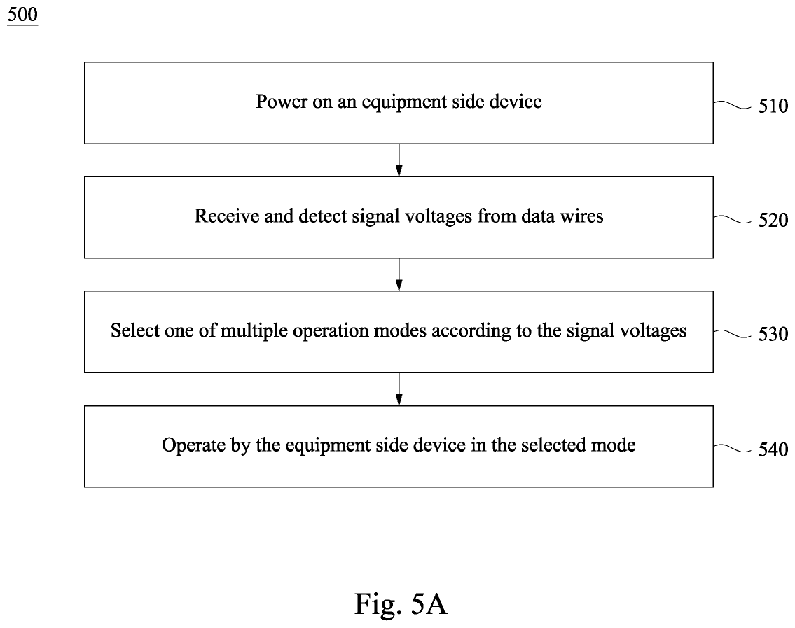

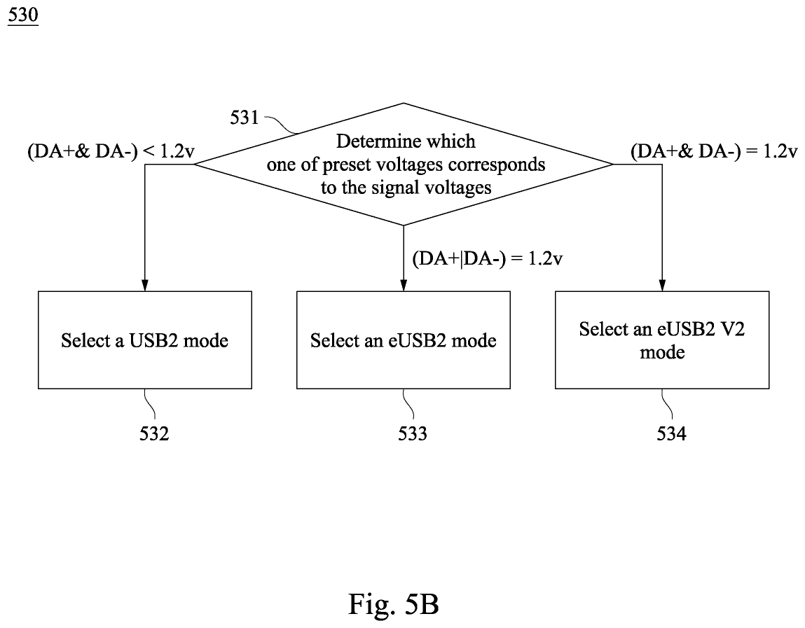

Reference is made FIG. 5A. FIG. 5A is a schematic diagram of a mode selection method 500 according to an embodiment of the present disclosure. As shown in FIG. 5A, the mode selection method 500 includes steps 510-540. In step 510, the equipment side device is powered on. In step 520, signal voltages are received and detected from data wires. In step 530, one of multiple operation modes is selected according to the signal voltages. In step 540, the equipment side device operates in the selected mode.

Reference is made to FIG. 5B. FIG. 5B is a schematic diagram of step 530 of the mode selection method 500 of FIG. 5A according to an embodiment of the present disclosure. As shown in FIG. 5B, step 530 includes steps 531-534. In step 532, the USB2 mode is selected. In step 533, the eUSB2 mode is selected. In step 534, the eUSB V2 mode is selected.

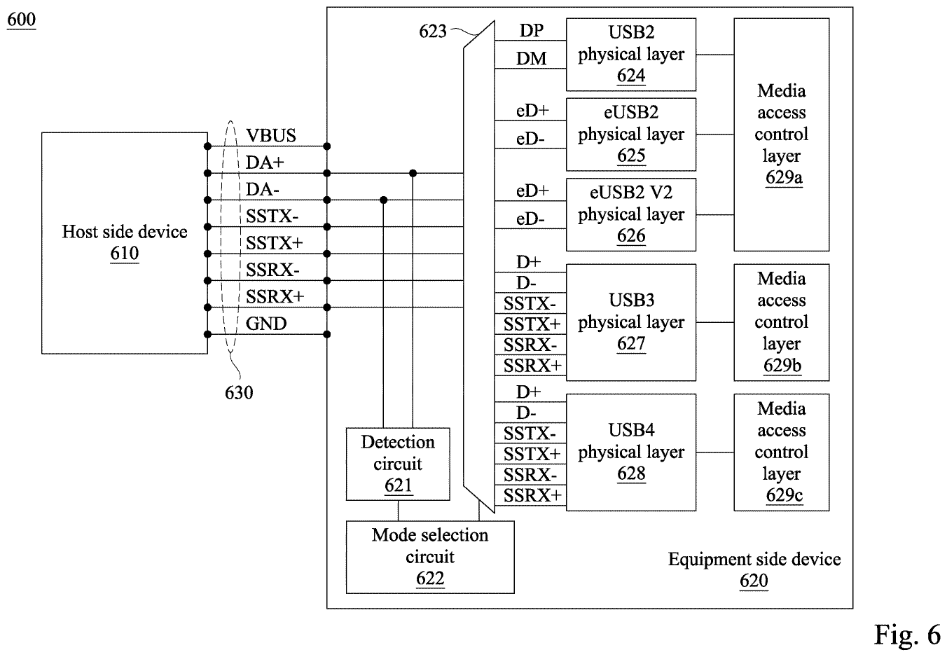

Reference is made FIG. 6. FIG. 6 is a schematic diagram of a communication architecture 600 of a universal serial bus device according to an embodiment of the present disclosure. In some embodiments, the host side device 610 corresponds to the host side device 310 of FIG. 3, and are not described in detail here.

In FIG. 6, the USB device on the device side is an equipment side device 620 as an example. In some embodiments, the equipment side device 620 includes a detection circuit 621, a mode selection circuit 622, a de-multiplexer circuit 623, at least two of multiple physical layers (e.g., a USB2 physical layer 624, an eUSB2 physical layer 625, an eUSB2 V2 physical layer 626, a USB3 physical layer 627, and a USB4 physical layer 628), and at least one of media access control layers (e.g., media access control layers 629a-629c). In some embodiments, the functions and operations of the de-multiplexer circuit 623, the USB2 physical layer 624, the eUSB2 physical layer 625, the eUSB2 V2 physical layer 626, the USB3 physical layer 627, the USB4 physical layer 628, and the media access control layers 629a-629c correspond to the de-multiplexer circuit 323, the USB2 physical layer 324, the eUSB2 physical layer 325, the eUSB2 V2 physical layer 326, the USB3 physical layer 327, the USB4 physical layer 328, and the media access control layers 329a-329c in FIG. 3, respectively, and are not described in detail here. In some embodiments, the functions and operations of the mode selection circuit 622 and the detection circuit 621 correspond to those of the mode selection circuit 422 and the detection circuit 421 in FIG. 4, and are not described in detail here.

In summary, the USB device and the mode selection method in the present disclosure can automatically select the operation mode of the USB device, thereby communicating with the host side device and transmitting data.

Although the present disclosure has been disclosed in the above embodiments, it is not intended to limit the present disclosure. Any person with ordinary knowledge in the art can make various changes and modifications without departing from the spirit and scope of the present disclosure. Therefore, the scope of protection of the present disclosure shall be based on the scope defined by the claims.

What is claimed is:

1. A universal serial bus device, comprising:
a detection circuit, configured to detect a supply voltage supplied by a host side device from a power wire;
a de-multiplexer circuit, electrically connected between multiple data wires and multiple physical layers; and
a mode selection circuit, electrically connected to the detection circuit and the de-multiplexer circuit, and configured to:
select one of multiple operation modes as a selected mode according to the supply voltage; and
control the de-multiplexer circuit to connect the data wires to one of the physical layers according to the selected mode, such that the universal serial bus device operates in the selected mode.

2. The universal serial bus device according to claim 1, wherein the mode selection circuit is further configured to:
determine that one of multiple preset voltages corresponds to the supply voltage; and
select one of the operation modes as the selected mode according to the corresponding one of the preset voltages, wherein the preset voltages are different from each other, and wherein the preset voltages are used for setting the mode of the universal serial bus device to the operation modes, respectively.

3. The universal serial bus device according to claim 2, wherein the operation modes comprise at least two of USB2 mode, embedded USB2 mode, and embedded USB2 version 2 mode.

4. The universal serial bus device according to claim 3, wherein the preset voltages comprise first to third preset voltages, wherein the first preset voltage is higher than the second preset voltage, the second preset voltage is higher than the third preset voltage, and wherein:
the first preset voltage is sufficient to enable the universal serial bus device to operate in the USB2 mode;
the second preset voltage is sufficient to enable the universal serial bus device to operate in the embedded USB2 mode; and
the third preset voltage is sufficient to enable the universal serial bus device to operate in the embedded USB2 version 2 mode.

5. The universal serial bus device according to claim 2, wherein the operation modes comprise at least two of USB2 mode, embedded USB2 mode, embedded USB2 version 2 mode, USB3 mode, and USB4 mode.

6. The universal serial bus device according to claim 1, wherein the physical layers comprise at least two of USB2 physical layer, embedded USB2 physical layer, embedded USB2 version 2 physical layer, USB3 physical layer, and USB4 physical layer.

7. The universal serial bus device according to claim 1, wherein the universal serial bus device is an equipment side device, a repeater or a USB hub.

8. The universal serial bus device according to claim 1, wherein the universal serial bus device is On-The-Go device with dual-role function.

9. A mode selection method for universal serial bus device, wherein the universal serial bus device comprises a detection circuit, a de-multiplexer circuit and a mode selection circuit, wherein the de-multiplexer circuit is electrically connected between multiple data wires and multiple physical layers, wherein the mode selection circuit is electrically connected to the detection circuit and the de-multiplexer circuit, wherein the mode selection method comprises:
detecting, by the detection circuit, a supply voltage supplied by a host side device from a power wire;
selecting, by the mode selection circuit, one of multiple operation modes as a selected mode according to the supply voltage; and
controlling, by the mode selection circuit, the de-multiplexer circuit to connect the data wires to one of the physical layers according to the selected mode, such that the universal serial bus device operates in the selected mode.

10. The mode selection method according to claim 9, further comprising:
determining, by the mode selection circuit, that one of multiple preset voltages corresponds to the supply voltage; and
selecting, by the mode selection circuit, one of the operation modes as the selected mode according to the corresponding one of the preset voltages.

11. The mode selection method according to claim 10, wherein the preset voltages are different from each other, and wherein the preset voltages are used for setting the mode of the universal serial bus device to the operation modes respectively.

12. A universal serial bus device, comprising:
a detection circuit, configured to detect multiple signal voltages supplied by a host side device from multiple data wires;
a de-multiplexer circuit, electrically connected between the data wires and multiple physical layers; and
a mode selection circuit, electrically connected to the detection circuit and the de-multiplexer circuit, and configured to:
select one of multiple operation modes as a selected mode according to the signal voltages; and
control the de-multiplexer circuit to connect the data wires to one of the physical layers according to the selected mode, such that the universal serial bus device operates in the selected mode.

13. The universal serial bus device according to claim 12, wherein the mode selection circuit is further configured to:
determine that one of multiple preset voltage groups corresponds to the signal voltages; and
select one of the operation modes as the selected mode according to the corresponding one of the preset voltage groups, and wherein the preset voltage groups are used for setting the mode of the universal serial bus device to the operation modes, respectively.

14. The universal serial bus device according to claim 13, wherein the data wires comprise a first data wire and a second data wire, and the signal voltages comprise a first signal voltage and a second signal voltage.

15. The universal serial bus device according to claim 14, wherein the preset voltage groups comprise preset first to third voltage groups, and wherein:
if the first and second signal voltages are both less than a predetermined value, the first and second signal voltages conform to the first voltage group;
if one of the first and second signal voltages is equal to the predetermined value, and the other of the first and second signal voltages is not equal to the predetermined value, the first and second signal voltages conform to the second voltage group; and
if the first and second signal voltages are both equal to the predetermined value, the first and second signal voltages conform to the third voltage group.

16. The universal serial bus device according to claim 12, wherein the operation modes comprise at least two of USB2 mode, embedded USB2 mode and USB2 version 2 mode.

17. The universal serial bus device according to claim 12, wherein the operation modes comprise at least two of USB2 mode, embedded USB2 mode, USB2 version 2 mode, USB3 mode and USB4 mode.

18. The universal serial bus device according to claim 12, wherein the physical layers comprise at least two of USB2 physical layer, embedded USB2 physical layer, embedded USB2 version 2 physical layer, USB3 physical layer, and USB4 physical layer.

19. The universal serial bus device according to claim 12, wherein the universal serial bus device is an equipment side device, a repeater, or a USB hub.

20. The universal serial bus device according to claim 12, wherein the universal serial bus device is On-The-Go device with dual-role function.
